(19) United States
(12) Patent Application Publication
(10) Pub. No.: US 2026/0107312 A1
(43) Pub. Date: Apr. 16, 2026

(54) SYSTEMS AND METHODS TO REDUCE PRACH COLLISION IN SBFD-AWARE UEs

(71) Applicant: Charter Communications Operating, LLC, St. Louis, MO (US)

(72) Inventor: Mojtaba Ahmadi Almasi, Portland, OR (US)

(21) Appl. No.: 18/913,097

(22) Filed: Oct. 11, 2024

(51) Int. Cl. H04W 74/0833; H04L 5/14

(52) U.S. Cl. CPC H04W 74/0833; H04L 5/14

(57) ABSTRACT

The present disclosure provides a method for reducing Physical Random Access Channel (PRACH) collision between sub-band full duplex (SBFD)-aware User Equipment (UE) and non-SBFD UEs during a contention-based random access (CBRA) procedure. The method includes selecting a PRACH resource based on detected SSBs and SBFD awareness, determining a collision avoidance random access radio network temporary identifier (RA-RNTI) using a collision avoidance process that includes an SBFD identifier (SBFD_id) to distinguish between SBFD-aware UEs and non-SBFD UEs, transmitting a PRACH CBRA-preamble using the selected PRACH resource, and receiving a random access response from a base station based on the collision avoidance RA-RNTI.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present disclosure relates to wireless communication systems, and more particularly to methods and systems for reducing Physical Random Access Channel (PRACH) collision in Sub-Band Full Duplex (SBFD)-aware User Equipment (UE).

### BACKGROUND

Wireless communication systems have evolved significantly over the past decades, with each new generation bringing improvements in speed, capacity, and reliability. As we move towards more advanced networks, such as 5G and beyond, the need for efficient and reliable initial access procedures becomes increasingly critical. One key component of these procedures is the Physical Random Access Channel (PRACH), which allows User Equipment (UE) to establish initial communication with the network.

In current cellular systems, the random access procedure typically involves several steps, including the transmission of a PRACH preamble by the UE and the subsequent response from the base station. This process is crucial for various network operations, such as initial access, handover, and beam failure recovery. However, as network deployments become more complex and user demands increase, challenges such as PRACH collision and inefficient resource utilization have emerged.

Recent advancements in wireless technology have introduced new concepts like Sub-Band Full Duplex (SBFD) operation, which allows simultaneous transmission and reception in different frequency sub-bands. While SBFD offers potential benefits in terms of spectral efficiency, it also introduces new considerations for random access procedures, particularly for SBFD-aware UEs.

The current random access procedures, as defined in 3GPP specifications, may not fully leverage the capabilities of SBFD-aware UEs or address the specific challenges they face. For instance, the calculation of Random Access Radio Network Temporary Identifier (RA-RNTI) in existing systems does not account for SBFD awareness, potentially leading to collisions between SBFD-aware and non-SBFD UEs.

Furthermore, the increasing density of network deployments and the introduction of new use cases in 5G and beyond networks have heightened the importance of efficient PRACH resource utilization and reduced collision probability. This is particularly crucial in scenarios involving massive Machine-Type Communications (mMTC) or ultra-reliable low-latency communications (URLLC), where a large number of devices may attempt access simultaneously or where rapid, reliable access is essential.

As the wireless communication landscape continues to evolve, there is a growing need for enhanced random access procedures that can accommodate new technologies like SBFD while improving overall system performance. This includes developing methods to reduce PRACH collision, optimize resource selection, and enhance the efficiency of initial access procedures for both SBFD-aware and traditional UEs.

Addressing these challenges requires innovative approaches to random access channel design, resource allocation, and UE behavior, particularly in the context of SBFD-aware operations. Such advancements will be crucial in realizing the full potential of next-generation wireless networks and meeting the diverse and demanding requirements of future communication systems.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for reducing Physical Random Access Channel (PRACH) collision between sub-band full duplex (SBFD)-aware User Equipment (UE) and non-SBFD UEs during a contention-based random access (CBRA) procedure is provided. The method includes receiving configuration information for a CBRA procedure, determining available PRACH resources, detecting synchronization signal blocks (SSBs), selecting a PRACH resource based on the detected SSBs and SBFD awareness, determining a random access radio network temporary identifier (RA-RNTI) using a collision avoidance method that includes an SBFD identifier (SBFD_id) to distinguish between SBFD-aware UEs and non-SBFD UEs, transmitting a PRACH CBRA-preamble using the selected PRACH resource, and receiving a random access response from a base station based on the calculated RA-RNTI.

According to other aspects of the present disclosure, the method may include one or more of the following features. The configuration information may include a PRACH configuration index, a PRACH format, a PRACH time-frequency resource allocation, and a set of available SSB indices. Determining the set of available PRACH resources may comprise identifying time-frequency resources allocated for PRACH transmission and mapping the identified time-frequency resources to corresponding SSB indices. Detecting the SSBs may comprise performing a cell search procedure to identify candidate SSBs and measuring signal quality for each of the identified candidate SSBs. Selecting the PRACH resource may comprise identifying a subset of SSBs with signal quality above a predetermined threshold, determining an SSB-to-RACH occasion mapping based on the SBFD awareness, and selecting the PRACH resource associated with a highest quality SSB from the subset of SSBs. The method may further comprise determining a transmission power for the PRACH CBRA-preamble based on path loss measurements of the detected SSBs. The SBFD awareness may comprise knowledge of frequency locations of SSBs within a carrier bandwidth. The configuration information includes SSB/PBCH information, the SSB/PBCH information comprising at least one of: (i) SIB-1 in 5G, or (ii) SIB-2 in LTE; and the set of available PRACH resources includes at least one system frame number and at least one sub-frame number. The CBRA procedure may be performed as part of an initial access, a handover, or a beam failure recovery process. The method may further comprise adjusting a contention window size based on the success or failure of the CBRA procedure.

According to another aspect of the present disclosure, a system for reducing Physical Random Access Channel (PRACH) collision in sub-band full duplex (SBFD)-aware operation is provided. The system includes a base station and a User Equipment (UE) comprising a transceiver, a memory, and a processor coupled to the transceiver and the memory. The processor is configured to receive configuration information for a CBRA procedure from the base station, determine available PRACH resources, detect SSBs, select a PRACH resource based on the detected SSBs and SBFD awareness, calculate an RA-RNTI using a formula that includes an SBFD identifier to distinguish between SBFD-aware UEs and non-SBFD UEs when they share a same last Random Access Channel (RACH) occasion (RO), transmit a PRACH CBRA-preamble using the selected PRACH resource, and receive a random access response from the base station based on the calculated RA-RNTI.

According to other aspects of the present disclosure, the system may include one or more of the following features. The configuration information may include a PRACH configuration index, a PRACH format, a PRACH time-frequency resource allocation, and a set of available SSB indices. The processor may be further configured to identify time-frequency resources allocated for PRACH transmission and map the identified time-frequency resources to corresponding SSB indices. The processor may be further configured to perform a cell search procedure to identify candidate SSBs and measure signal quality for each of the identified candidate SSBs. The processor may be further configured to identify a subset of SSBs with signal quality above a predetermined threshold, determine an SSB-to-RACH occasion mapping based on the SBFD awareness, and select the PRACH resource associated with a highest quality SSB from the subset of SSBs. The processor may be further configured to determine a transmission power for the PRACH CBRA-preamble based on path loss measurements of the detected SSBs. The SBFD awareness may comprise knowledge of frequency locations of SSBs within a carrier bandwidth. The configuration information includes SSB/PBCH information, the SSB/PBCH information comprising at least one of: (i) SIB-1 in 5G, or (ii) SIB-2 in LTE; and the set of available PRACH resources includes at least one system frame number and at least one sub-frame number. The CBRA procedure may be performed as part of an initial access, a handover, or a beam failure recovery process. The processor may be further configured to adjust a contention window size based on the success or failure of the CBRA procedure.

In a more generic embodiment, the present disclosure provides a method for reducing collisions in wireless communication systems using full duplex operation. The method includes receiving configuration information for a random access procedure, selecting a random access resource based on detected synchronization signals and full duplex awareness, calculating an identifier using a formula that distinguishes between full duplex-aware and non-full duplex-aware devices, transmitting a random access signal using the selected resource, and receiving a response based on the calculated identifier.

Additional embodiments include a method for dynamically adjusting PRACH resources based on SBFD-aware UE density in a network, a system for coordinating PRACH resource allocation between SBFD-aware and non-SBFD UEs to minimize collisions, a method for adaptive RA-RNTI calculation based on network congestion and SBFD-aware UE distribution, a UE configured to switch between SBFD-aware and non-SBFD PRACH procedures based on network conditions, and a base station configured to manage separate PRACH resource pools for SBFD-aware and non-SBFD UEs.

In another aspect, a computerized device implementing one or more of the foregoing aspects is disclosed and described. In one embodiment, the device includes a personal or laptop computer. In another embodiment, the device includes a mobile device (e.g., tablet or smartphone). In another embodiment, the device includes a base station.

In another aspect, an integrated circuit (IC) device implementing one or more of the foregoing aspects is disclosed and described. In one embodiment, the IC device is embodied as a SoC (system on Chip) device. In another embodiment, an ASIC (application specific IC) is used as the basis of the device. In yet another embodiment, a chip set (i.e., multiple ICs used in coordinated fashion) is disclosed. In yet another embodiment, the device includes a multi-logic block FPGA device.

In another aspect, a computer readable storage apparatus implementing one or more of the foregoing aspects is disclosed and described. In one embodiment, the computer readable apparatus includes a program memory, or an EEPROM. In another embodiment, the apparatus includes a solid state drive (SSD) or other mass storage device. In another embodiment, the apparatus includes a USB or other “flash drive” or other such portable removable storage device. In yet another embodiment, the apparatus includes a “cloud” (network) based storage device which is remote from yet accessible via a computerized user or client electronic device. In yet another embodiment, the apparatus includes a “fog” (network) based storage device which is distributed across multiple nodes of varying proximity and accessible via a computerized user or client electronic device.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates an existing Type-1 Contention-Based Random Access communication process, in an embodiment.

FIG. 2 shows an existing Type-2 Contention-Based Random Access communication process, in an embodiment.

FIG. 3 illustrates a frame structure for a wireless communication system, in an embodiment.

FIG. 4 depicts a Random Access Channel configuration and Random Access Response configuration, in an embodiment.

FIG. 5 illustrates a frame structure with Sub-band Full Duplex capabilities, in an embodiment.

FIG. 6 shows a random access channel configuration with SBFD and non-SBFD Random Occasions, in an embodiment.

FIG. 7 depicts a modified Type-1 random access channel procedure for SBFD-aware UEs, in an embodiment.

FIG. 8 illustrates a modified Type-2 random access channel procedure for SBFD-aware UEs, in an embodiment.

FIG. 9 shows a MSGA-transmission, which includes a PRACH transmitted in RO 1 and a PUSCH transmitted in PUSCH Occasion 1 (PO 1), in an embodiment.

FIG. 10 illustrates a random access configuration for FR1 and unpaired spectrum, in an embodiment.

### DEFINITIONS

PRACH: Physical Random Access Channel—a communication channel used by User Equipment (UE) to initiate contact with a base station in cellular networks. PRACH allows UEs to request initial access to the network, perform handovers, or recover from connection failures. For example, when a smartphone is turned on and needs to connect to a nearby cell tower, it uses PRACH to send a random access preamble and begin the process of establishing a connection.

SBFD: Sub-Band Full Duplex—a technology that enables simultaneous transmission and reception of signals on different frequency sub-bands within the same carrier. SBFD can potentially improve spectral efficiency and network capacity in wireless communications. In an SBFD-enabled system, a base station might transmit data on one sub-band while simultaneously receiving data on another sub-band, effectively increasing the overall data throughput.

SSB: Synchronization Signal Block—a set of signals transmitted by a base station to help UEs discover and synchronize with the network. SSBs contain essential information for initial access, including timing and frequency synchronization, as well as cell identification. For instance, when a UE enters a new area, it scans for SSBs to identify available networks and align its timing with the chosen network before attempting to connect.

UE: User Equipment—any device used by an end-user to communicate over a cellular network. UEs can include smartphones, tablets, IoT devices, or any other mobile communication equipment. For example, a smartwatch with cellular capabilities is considered a UE when it connects to a mobile network to send and receive data.

gNB: Next Generation Node B—the base station in 5G networks, responsible for radio transmission and reception with UEs. gNBs manage radio resources, perform scheduling, and handle various network functions. In a 5G network deployment, multiple gNBs work together to provide seamless coverage and high-speed connectivity to users across a wide area.

CBRA: Contention-Based Random Access—a method of network access where multiple UEs compete for the same resources to establish a connection. CBRA is typically used when a UE does not have dedicated resources assigned by the network. For instance, when multiple smartphones attempt to connect to a network simultaneously in a crowded area, they use CBRA to compete for available resources.

CFRA: Contention-Free Random Access—a method of network access where the network allocates dedicated resources to specific UEs, eliminating competition for resources. CFRA is often used for time-sensitive operations or when the network needs to ensure successful access for certain UEs. An example of CFRA usage is during a handover process, where the network allocates specific resources to ensure a seamless transition between cells.

RO: RACH Occasion—a specific time-frequency resource allocated for random access attempts. ROs are defined by the network and communicated to UEs to coordinate when and where random access attempts can be made. For example, a base station might configure ROs to occur periodically every 10 milliseconds on specific frequency resources to manage network access efficiently.

TC-RNTI: Temporary Cell Radio Network Temporary Identifier—a temporary identifier assigned to a UE during the random access procedure. The TC-RNTI is used for initial communication between the UE and the network before a permanent identifier is assigned. When a UE successfully completes the initial stages of random access, it receives a TC-RNTI from the network to use for subsequent communications until a permanent C-RNTI is assigned.

C-RNTI: Cell Radio Network Temporary Identifier—a unique identifier assigned to a UE by the network for ongoing communications within a cell. The C-RNTI is used to distinguish between different UEs connected to the same cell and is essential for proper routing of data and control messages. For instance, when a base station needs to send scheduling information to a specific UE, it uses the C-RNTI to ensure the information reaches the correct device.

PUSCH: Physical Uplink Shared Channel—a channel used for transmitting user data from the UE to the base station in cellular networks. PUSCH carries information such as application data, control information, and other uplink transmissions. For example, when a user uploads a photo to social media using their smartphone, the data is transmitted over the PUSCH to the base station.

mMTC: massive Machine-Type Communications—a use case in 5G networks designed to support a very large number of connected devices typically transmitting a relatively low volume of non-delay-sensitive data. mMTC is crucial for IoT applications and smart city deployments. For instance, in a smart agriculture scenario, thousands of soil sensors might use mMTC to periodically report moisture levels to a central system.

URLLC: Ultra-Reliable Low-Latency Communications—a 5G use case that aims to provide very low latency and extremely high reliability for critical applications. URLLC is essential for applications such as autonomous vehicles, industrial automation, and remote surgery. For example, in a smart factory, URLLC might be used to ensure real-time control of robotic arms with minimal delay and maximum reliability.

RA-RNTI: Random Access Radio Network Temporary Identifier—serves as a critical identifier during random access, enabling efficient and reliable communication between the UE and the network. When a User Equipment (UE) wants to initiate communication with the 5G network, it sends a Random Access Preamble, which helps the network identify the UE's intent to establish a connection. Upon detecting the preamble, the network assigns an RA-RNTI to the UE, which helps distinguish between different UEs attempting simultaneous access, ensuring proper network responses.

RAR: Random Access Response—a message sent by the base station in response to a PRACH preamble transmission from a UE during the random access procedure. The RAR contains critical information such as timing advance commands, uplink grant for subsequent transmissions, and a temporary identifier for the UE. For example, when a smartphone initiates a random access procedure, it sends a PRACH preamble, and the network responds with an RAR that allows the smartphone to adjust its timing and prepare for further communication with the base station.

RAPID: Random Access Preamble IDentifier—a unique identifier assigned to each random access preamble in a set of available preambles for PRACH transmission. The RAPID is used by the network to distinguish between different preambles sent by UEs during the random access procedure. For example, when multiple UEs attempt to access the network simultaneously, each UE selects a preamble with a specific RAPID, allowing the base station to identify and respond to individual access attempts efficiently.

RRC: Radio Resource Control—a protocol layer in 5G networks responsible for managing the connection between User Equipment (UE) and the network. RRC handles crucial functions such as establishing, maintaining, and releasing radio connections, as well as configuring lower layers of the protocol stack. For example, when a smartphone needs to transition from idle mode to connected mode to make a call or access data services, the RRC protocol manages this state transition and sets up the necessary radio bearers for communication.

DCI: Downlink Control Information—a message sent by the base station to User Equipment (UE) on the Physical Downlink Control Channel (PDCCH) to convey essential control information for scheduling and resource allocation. DCI contains critical parameters such as modulation and coding scheme, resource block allocation, and transmission power control commands. For example, when a smartphone needs to receive data, the base station sends a DCI message specifying which time-frequency resources the phone should monitor for its data, ensuring efficient use of network resources and coordinating multiple users' transmissions.

PDCCH: Physical Downlink Control Channel—a communication channel used by base stations to transmit control information to User Equipment (UE) in cellular networks. The PDCCH carries Downlink Control Information (DCI) messages, which contain essential scheduling and resource allocation information. This channel may be used to convey data such as uplink and downlink resource assignments, modulation and coding schemes, power control commands, and HARQ feedback. For instance, when a UE needs to receive data, the base station may use the PDCCH to inform the UE about which time-frequency resources to monitor and what transmission parameters to use, enabling efficient coordination of network resources among multiple users.

CLI: Cross-Link Interference—a type of interference in wireless communication systems where uplink and downlink transmissions from different cells or network nodes interfere with each other. CLI typically occurs in Time Division Duplex (TDD) networks when transmission directions are misaligned between neighboring cells. For example, in a 5G network with dense small cell deployment, the uplink transmission from a user device in one cell may interfere with the downlink reception of a device in an adjacent cell, potentially degrading signal quality and overall network performance.

sym_id: A parameter used in the calculation of the Random Access Radio Network Temporary Identifier (RA-RNTI). It represents the index of the first OFDM symbol of the Physical Random Access Channel (PRACH) occasion within a slot. The sym_id value is used to uniquely identify the specific symbol where the random access preamble transmission begins, allowing the network to accurately locate and process the random access attempt. For example, in a slot with multiple PRACH occasions, each occasion may have a different sym_id value, enabling precise timing and resource allocation for random access procedures.

slot_id: A parameter used in the calculation of the Random Access Radio Network Temporary Identifier (RA-RNTI). It represents the index of the slot containing the Physical Random Access Channel (PRACH) occasion within a system frame. The slot_id value helps identify the specific time slot in which a random access attempt occurs, enabling the network to accurately process and respond to random access requests. For example, in a 5G NR frame structure with multiple slots, each slot may be assigned a unique slot_id, allowing precise timing and resource management for random access procedures across different subcarriers and numerologies.

freq_id: A parameter used in the calculation of the Random Access Radio Network Temporary Identifier (RA-RNTI). It represents the frequency index of the Physical Random Access Channel (PRACH) occasion within the system bandwidth. The freq_id value helps identify the specific frequency resource where a random access attempt occurs, enabling the network to accurately locate and process random access requests across different frequency allocations. For example, in a 5G NR system with multiple frequency resources available for PRACH, each resource may be assigned a unique freq_id, allowing efficient management of random access procedures across various parts of the frequency spectrum.

ul_carrier_id: A parameter used in the calculation of the Random Access Radio Network Temporary Identifier (RA-RNTI). It represents the identifier of the uplink carrier associated with the Physical Random Access Channel (PRACH) transmission. The ul_carrier_id helps distinguish between different uplink carriers in multi-carrier or carrier aggregation scenarios, enabling the network to accurately process random access attempts on specific carriers. For example, in a 5G NR system supporting multiple uplink carriers, each carrier may be assigned a unique ul_carrier_id, allowing the network to manage random access procedures independently across different frequency bands or component carriers.

SBFD_id: A parameter used in the calculation of the Random Access Radio Network Temporary Identifier (RA-RNTI) for Sub-Band Full Duplex (SBFD)-aware User Equipment (UE). The SBFD_id is used to distinguish between SBFD-aware UEs and non-SBFD UEs when they share the same last Random Access Channel (RACH) occasion (RO). For example, SBFD_id may be set to 0 for non-SBFD ROs and 1 for SBFD ROs, allowing the network to differentiate between SBFD-aware and non-SBFD UEs during the random access procedure.

PRACH CBRA-preamble: A specific type of Physical Random Access Channel (PRACH) preamble used in Contention-Based Random Access (CBRA) procedures. This preamble is transmitted by the UE to initiate the random access process in scenarios where multiple UEs may be competing for the same network resources. For instance, when an SBFD-aware UE attempts to establish an initial connection with the network, it may transmit a PRACH CBRA-preamble using a selected PRACH resource.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

In accordance with various aspects of the present disclosure, systems and methods are provided for reducing Physical Random Access Channel (PRACH) collision in Sub-Band Full Duplex (SBFD)-aware User Equipment (UE). The disclosed techniques may be implemented in wireless communication networks, including but not limited to 5G and beyond networks.

In some aspects, the present disclosure introduces novel Random Access Radio Network Temporary Identifier (RA-RNTI) computation methods for both Type-1 and Type-2 Contention-Based Random Access (CBRA) procedures. These methods may incorporate an SBFD identifier (SBFD_id) to distinguish between SBFD-aware and non-SBFD UEs during random access procedures.

For Type-1 CBRA, which typically involves a four-step message exchange between the UE and the base station, the RA-RNTI may be calculated using the following function, with RA-RNTI_New as a binary function of SBFD_id:

$$RA ‐ RNTI = RA ‐ RNTI\_Original + RA ‐ RNTI\_New ( SBFD\_id ) ,$$

or shown another way,

$$RA ‐ RNTI\_Original + RA ‐ RNTI\_New \times SBFD\_id .$$

One example of this for a Type-1 CBRA equation is:

$$RA ‐ RNTI = 1 + sym\_id + 14 \times slot\_id + 14 \times 80 \times freq\_id + 14 \times 80 \times 8 \times ul\_carrier \_id + 14 \times 80 \times 8 \times 4 \times SBFD\_id ,$$

$$where :$$

$$RA ‐ RNTI\_Original = 1 + sym\_id + 14 \times slot\_id + 14 \times 80 \times freq\_id + 14 \times 80 \times 8 \times ul\_carrier \_id ,$$

$$RA ‐ RNTI\_New \_ 1 = 14 \times 80 \times 8 \times 4 , and$$

SBFD_id=1 if sub-band full duplex or 0 if not sub-band full duplex.

This calculation method for Type-1 CBRA may allow for differentiation between SBFD-aware and non-SBFD UEs during the initial access, handover, or beam failure recovery processes. The inclusion of the SBFD_id term (denoting SBFD-aware and non-SBFD UEs) at the end of the equation may enable the network to allocate resources more efficiently for SBFD-aware UEs. Further, this may ensure collisions do not occur between SBFD-aware and non-SBFD UEs by spacing an SBFD-aware UE's RA-RNTI calculated value away from a non-SBFD UE's calculated RA-RNTI value.

In contrast, Type-2 CBRA, which is designed to reduce random access time by combining multiple messages, may utilize a different RA-RNTI calculation method. For Type-2 CBRA, one example of a RA-RNTI equation may be calculated as follows:

$$RA ‐ RNTI = 1 + sym\_id + 14 \times slot\_id + 14 \times 80 \times freq\_id + 14 \times 80 \times 8 \times ul\_carrier \_id + 14 \times 80 \times 8 \times 2 + 14 \times 80 \times 8 \times 6 \times SBFD\_id ,$$

$$where :$$

$$RA ‐ RNTI\_Original = 1 + sym\_id + 14 \times slot\_id + 14 \times 80 \times freq\_id + 14 \times 80 \times 8 \times ul\_carrier \_id + 14 \times 80 \times 8 \times 2 ,$$

$$RA ‐ RNTI\_New \_ 2 = 14 \times 80 \times 8 \times 6 , and$$

SBFD_id=1 if sub-band full duplex aware or 0 if not sub-band full duplex aware.

The key difference in the Type-2 CBRA equation is the addition of a constant term (14×80×8×6) and a modified coefficient for the SBFD_id term. These changes may account for the unique structure of Type-2 CBRA, where MSGA combines traditional MSG1 and MSG3, and MSGB combines MSG2 and MSG4. In addition, the difference between the Type-1 and Type-2 calculations (“14× 80×8×4” vs “14×80×8×6”) may ensure Type-1 and Type-2 communication do not collide with each other.

In both Type-1 and Type-2 CBRA implementations, the SBFD_id may be set to 0 for non-SBFD Random Occasions (ROs) and 1 for SBFD ROs. This distinction may allow the network to differentiate between SBFD-aware and non-SBFD UEs during the random access procedure, potentially reducing collisions and improving overall system performance. In addition, with non-SBFD UE's SBFD_id is set to zero, which results in the “RA-RNTI_New×SBFD_id” term equal to zero, rendering RA-RNTI in its original form, thus requiring no change for non-SBFD UEs.

The disclosed techniques may also include modifications to existing random access procedures to accommodate these new RA-RNTI calculations. Such modifications may involve optimizing resource selection for PRACH transmissions based on one or more of SBFD awareness and detected Synchronization Signal Blocks (SSBs), which may be applied differently in Type-1 and Type-2 CBRA scenarios.

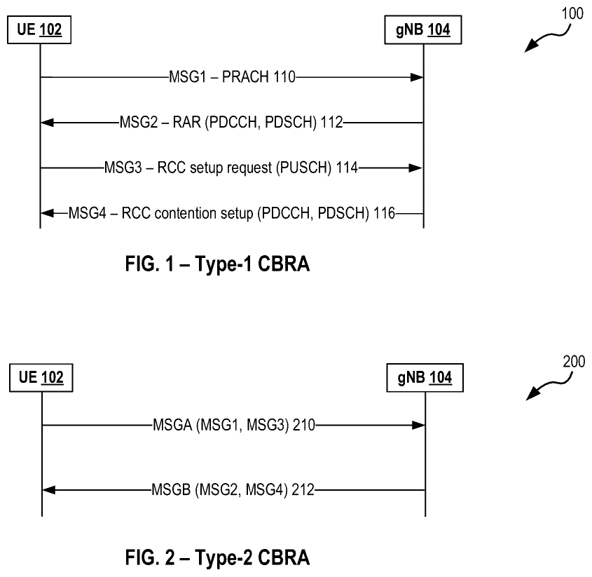

FIG. 1 shows an existing Type-1 Contention-Based Random Access (CBRA) communication process 100. The sequence diagram illustrates the four-step message exchange between a User Equipment (UE) 102 and a gNodeB (gNB) 104 in a cellular network.

In step 110, the UE 102 initiates the random access procedure by sending MSG1, which contains the Physical Random Access Channel (PRACH) preamble, to the gNB 104. Upon receiving MSG1, the gNB 104 responds in step 112 with MSG2, which is the Random Access Response (RAR). This message is transmitted on both the Physical Downlink Control Channel (PDCCH) and the Physical Downlink Shared Channel (PDSCH). The RAR typically includes timing advance information, uplink grant, and a temporary identifier for the UE.

Following the receipt of MSG2, the UE 102 proceeds to step 114, where it sends MSG3, which is an RRC (Radio Resource Control) setup request. This message is transmitted on the Physical Uplink Shared Channel (PUSCH) and typically includes the UE 102's identity and the reason for establishing the connection. The final step in this sequence is step 116, where the gNB 104 sends MSG4 to the UE 102. MSG4 is the RRC contention resolution message, which confirms the successful completion of the random access procedure and establishes the RRC connection.

In the current implementation, the Random Access Radio Network Temporary Identifier (RA-RNTI) for Type-1 CBRA is calculated using the following equation:

$$RA ‐ RNTI = 1 + sym\_id + 14 \times slot\_id + 14 \times 80 \times freq\_id + 14 \times 80 \times 8 \times ul\_carrier \_id$$

where:
sym_id is the index of the first OFDM symbol of the specified RACH occasion (0≤sym_id<14),
slot_id is the index of the first slot of the last RO in the RO group in a system frame (0≤slot_id<80),
freq_id is the index of the RACH occasion in the frequency domain (0≤freq_id<8), and
ul_carrier_id is the uplink carrier used for MSG1 transmission (0=normal uplink carrier, 1=SUL carrier).

This current RA-RNTI calculation method may have limitations when it comes to reducing PRACH collisions, particularly in scenarios involving SBFD-aware UEs. The equation does not account for SBFD awareness, which may lead to potential collisions between SBFD-aware and non-SBFD UEs attempting to access the network simultaneously.

To enhance coverage, Release 18 random access procedures may allow UEs to transmit multiple similar PRACH signals (i.e., PRACH repetitions). In such cases, the RA-RNTI is calculated based on the last RO's time and frequency position. This approach may result in UEs that share the last RO for PRACH transmission experiencing collisions, which can negatively impact the efficiency and reliability of the random access procedure.

These limitations in the current RA-RNTI calculation method may become more pronounced as network deployments become more complex and user demands increase, for example, in scenarios involving massive Machine-Type Communications (mMTC) or ultra-reliable low-latency communications (URLLC).

FIG. 2 shows an existing Type-2 Contention-Based Random Access (CBRA) communication process 200. The sequence diagram illustrates a streamlined two-step message exchange between a User Equipment (UE) 102 and a gNodeB (gNB) 104 in a cellular network.

The system comprises a base station (gNB 104) and a User Equipment (UE) 102. The UE 102 may comprise a transceiver, a memory, and a processor coupled to the transceiver and the memory. These components enable the UE to perform the necessary operations for the random access procedure.

In the Type-2 CBRA process, the UE initiates the random access procedure by sending MSGA (message 210) to the gNB. MSGA combines the traditional MSG1 (Random Access Preamble) and MSG3 (RRC Connection Request) into a single transmission. This consolidation of messages aims to reduce the overall random access time compared to the four-step Type-1 CBRA procedure.

Upon receiving MSGA, the gNB responds with MSGB (message 212). MSGB combines the traditional MSG2 (Random Access Response) and MSG4 (Contention Resolution) into a single message. This further streamlines the process by allowing the gNB to provide all necessary information for connection establishment in one transmission.

The current RA-RNTI calculation method for Type-2 CBRA is as follows:

$$RA ‐ RNTI = 1 + sym\_id + 14 \times slot\_id + 14 \times 80 \times freq\_id + 14 \times 80 \times 8 \times ul\_carrier \_id + 14 \times 80 \times 8 \times 2 ,$$

where:
sym_id is the index of the first OFDM symbol of the specified RACH occasion (0≤sym_id<14),
slot_id is the index of the first slot of the RACH occasion in a system frame (0≤slot_id<80),
freq_id is the index of the RACH occasion in the frequency domain (0≤freq_id<8), and
ul_carrier_id is the uplink carrier used for MSGA transmission (0=normal uplink carrier, 1=SUL carrier).

While this calculation method accounts for the unique structure of Type-2 CBRA, it may have limitations when it comes to accommodating SBFD-aware UEs.

For instance, if a legacy UE and an SBFD-aware UE transmit a PRACH signal in the same RACH Occasion (RO), their RA-RNTIs may be identical. This situation may result in a failed random access attempt for one of the UEs, as the network cannot distinguish between them based on the RA-RNTI alone.

These limitations may become more significant as networks evolve to support a mix of legacy and SBFD-aware UEs, potentially impacting the efficiency and reliability of the random access procedure in scenarios involving dense deployments or high-demand use cases.

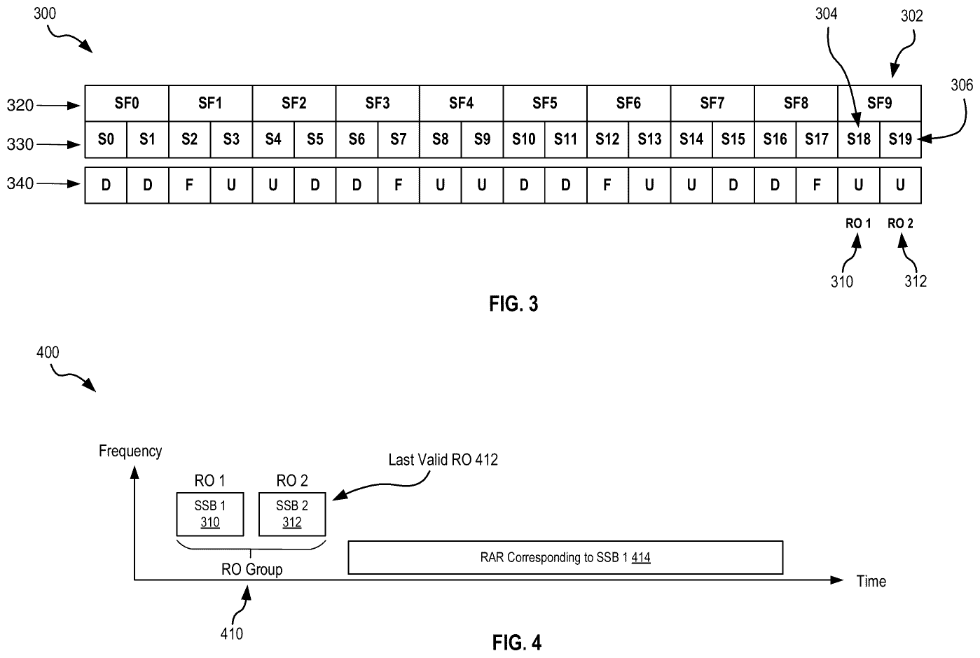

FIG. 3 illustrates a frame structure 300 for a wireless communication system.

Frame structure 300 is divided into multiple subframes, labeled SF 0 through SF 9. Each subframe is further divided into two slots, labeled S0 through S19. For example, a subframe 302 is divided into two slots 304 and 306. The slots are composed of symbols, which are designated as Downlink (D), Uplink (U), or Flexible (F). For example, slot S18 304 and slot S19 306 are shown with symbols “U” for uplink data.

The subframe row 320 displays the subframe numbers, while the slot row 330 shows the slot numbers within each subframe. The symbol row 340 indicates the type of symbols within each slot. In the present example, the pattern of symbol allocation repeats every five slots, with the sequence being D-D-F-U-U.

The last subframe 302, SF 9, contains slots S18 and S19. These slots are of particular interest in this frame structure. The last two symbols of the frame, corresponding to slots S18 and S19, are designated as uplink (U) symbols and are labeled as RACH Occasions (ROs).

The first RACH occasion 310 is labeled as RO 1 and corresponds to the symbol in slot S18. The second RACH occasion 312 is labeled as RO 2 and corresponds to the symbol in slot S19. These ROs represent specific time-frequency resources allocated for random access procedures within the system frame 300.

Table 6.3.3.2-3: Random access configurations for FR1 and unpaired spectrum of 3GPP TS 38.211 V16.0.0 (2019-12), titled “3rd Generation Partnership Project; Technical Specification Group Radio Access Network; NR; Physical channels and modulation; (Release 16)”, incorporated herein by reference in its entirety.

The frame structure 300 example is derived from PRACH Configuration Index 161 in Table 6.3.3.2-3: Random access configurations for FR1 and unpaired spectrum, below. For example, the structure uses the B4 preamble format, includes 9 subframes, the starting symbol is ‘0’, there are two slots per subframe (e.g., slots S18 304 and S19 306 in SF9 302), there is one time-domain PRACH occasion within a PRACH slot, and the PRACH duration is 12.

TABLE 6.3.3.2-3
Random access configurations for FR1 and unpaired spectrum.

| | | | | | | | Nₜ^{RA, slot}, | |
|---|---|---|---|---|---|---|---|---|
| | | | | | | | number | |
| | | | | | | | of time- | |
| | | | | | | Number | domain | |
| | | | | | | of | PRACH | |
| | | | | | | PRACH | occasions | |
| PRACH | | | | | | slots | within a | N_{dur}^{RA}, |
| Configuration | Preamble | | | Subframe | Starting | within a | PRACH | PRACH |
| Index | format | | | number | symbol | subframe | slot | duration |
| 0 | 0 | 16 | 1 | 9 | 0 | — | — | 0 |
| 1 | 0 | 8 | 1 | 9 | 0 | — | — | 0 |
| 2 | 0 | 4 | 1 | 9 | 0 | — | — | 0 |
| 3 | 0 | 2 | 0 | 9 | 0 | — | — | 0 |

. . .

| | | | | | | | | |
|---|---|---|---|---|---|---|---|---|
| 159 | B4 | 1 | 0 | 9 | 0 | 1 | 1 | 12 |
| 160 | B4 | 1 | 0 | 9 | 2 | 1 | 1 | 12 |
| 161 | B4 | 1 | 0 | 9 | 0 | 2 | 1 | 12 |
| 162 | B4 | 1 | 0 | 4, 9 | 2 | 1 | 1 | 12 |
| 163 | B4 | 1 | 0 | 7, 9 | 2 | 1 | 1 | 12 |
| 164 | B4 | 1 | 0 | 8, 9 | 0 | 2 | 1 | 12 |
| 165 | B4 | 1 | 0 | 3, 4, 8, 9 | 2 | 1 | 1 | 12 |
| 166 | B4 | 1 | 0 | 1, 3, 5, 7, 9 | 2 | 1 | 1 | 12 |
| 167 | B4 | 1 | 0 | 0, 1, 2, 3, 4, | 0 | 2 | 1 | 12 |
| | | | | 5, 6, 7, 8, 9 | | | | |
| 168 | B4 | 1 | 0 | 0, 1, 2, 3, 4, | 2 | 1 | 1 | 12 |
| | | | | 5, 6, 7, 8, 9 | | | | |

Frame structure 300 provides a representation of how time-frequency resources are organized and allocated in this wireless communication system, with specific provisions for random access procedures in the form of the ROs 310, 312 at the end of the frame. This organization may allow for efficient use of network resources while providing dedicated opportunities for UEs to initiate communication with the network.

FIG. 4 shows a time-frequency block structure diagram 400 illustrating the Random Access Channel (RACH) configuration and Random Access Response (RAR) process in a wireless communication system. The diagram is organized along two axes: frequency on the vertical axis and time on the horizontal axis. The process begins with an RO group 410, which consists of two Random Occasions (ROs) 310 and 312. The first RO, designated as RO 1 310, is associated with Synchronization Signal Block 1 (SSB 1). Immediately following RO 1 is RO 2 312, which is also associated with an SSB 1. These two ROs form a contiguous block in the time-frequency domain.

In diagram 400, the UE may detect one or more synchronization signal blocks (SSBs). The configuration information provided to the UE may include a set of available SSB indices. Determining the set of available PRACH resources may comprise mapping the identified time-frequency resources to corresponding SSB indices. This mapping allows the UE to associate specific ROs with particular SSBs, enabling efficient resource allocation and utilization during the random access procedure.

The process of detecting the one or more SSBs may comprise performing a cell search procedure to identify candidate SSBs. This cell search procedure allows the UE to discover and synchronize with nearby cells. Additionally, detecting the SSBs may involve measuring signal quality for each of the identified candidate SSBs. These measurements may help the UE select the most suitable SSB for initiating the random access procedure.

RO 2 is indicated as the “last valid RO” 412 in the RO group. This designation is crucial for the subsequent steps in the random access procedure, as it may determine the timing for the UE's PRACH transmission and the network's response.

Following the RO group 410, there is a time slot allocated for the Random Access Response (RAR) corresponding to SSB 1, labeled 414. This RAR period is significantly longer in duration compared to the individual ROs, allowing for the network to process the random access requests and formulate appropriate responses. The extended duration of the RAR period may accommodate multiple UEs attempting random access simultaneously, enhancing the system's ability to handle high-load scenarios.

Diagram 400 represents the complete cycle of a random access attempt, from the initial RO group to the corresponding RAR period. This structure allows for efficient coordination between UEs and the network during the random access procedure, potentially reducing collisions and improving overall system performance.

The relationship between ROs, SSBs, and the RAR period illustrated in this figure provide a framework for implementing advanced random access techniques, such as those required for SBFD-aware UEs or other emerging technologies in 5G and beyond networks.

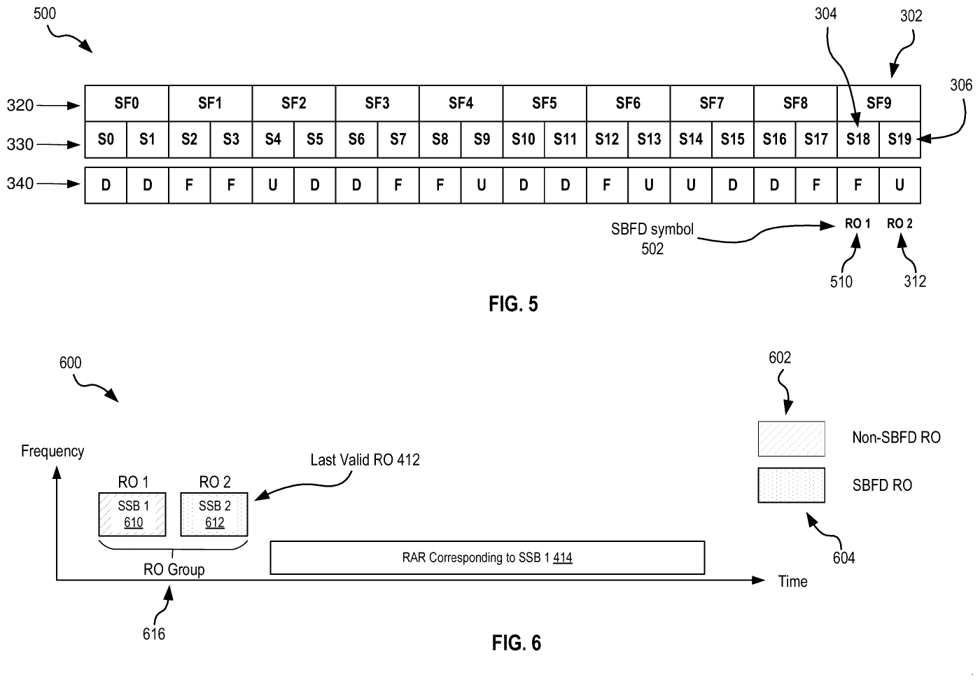

FIG. 5 shows a system frame structure 500 for a wireless communication system with Sub-band Full Duplex (SBFD) capabilities. The frame is divided into multiple subframes, labeled SF 0 through SF 9, with each subframe further divided into two slots, labeled S0 through S19. The slots are composed of symbols, designated as Downlink (D), Uplink (U), or Flexible (F), following a repeating pattern of D-D-F-F-U every five slots.

The last subframe 302, SF 9, is of particular interest as it contains slot S18 304 and slot S19 306. The symbol 510 slot S18 304, is designated as a SBFD symbol, as indicated by the SBFD symbol indicator 502. This designation is crucial for supporting SBFD-aware operations within the frame structure.

The first RACH occasion at symbol 510, labeled as RO 1, corresponds to the symbol in slot S18 304, while the second RACH occasion 312, labeled as RO 2, corresponds to the symbol in slot S19 306. These ROs represent specific time-frequency resources allocated for random access procedures within the system frame 500 that show one manner in which to incorporate SBFD capabilities with non-SBFD capabilities.

The SBFD awareness in this context comprises knowledge of frequency locations of SSBs within a carrier bandwidth. This awareness allows SBFD-capable UEs to more efficiently utilize the available spectrum and potentially reduce interference between uplink and downlink transmissions.

To support this SBFD-aware structure, a new RA-RNTI calculation method for Type-1 Contention-Based Random Access (CBRA) is introduced. The new formula includes an SBFD_id parameter:

$$RA ‐ RNTI = 1 + sym\_id + 14 \times slot\_id + 14 \times 80 \times freq\_id + 14 \times 80 \times 8 \times ul\_carrier \_id + 14 \times 80 \times 8 \times 4 \times SBFD\_id$$

Where SBFD_id is set to 0 for non-SBFD Random Occasions (ROs) and 1 for SBFD ROs. This new calculation method allows the network to differentiate between SBFD-aware and non-SBFD UEs during the random access procedure, potentially reducing collisions and improving overall system performance.

The incorporation of SBFD symbols in the frame structure, as shown by the SBFD symbol indicator 502, provides dedicated resources for SBFD operations. This may allow for more efficient use of the spectrum, as SBFD-aware UEs can potentially transmit and receive simultaneously in different frequency sub-bands within these symbols.

By integrating SBFD symbols into the frame structure and modifying the RA-RNTI calculation method, the system can support advanced random access procedures for SBFD-aware UEs while maintaining compatibility with non-SBFD UEs. This flexibility may enable smoother transitions to SBFD technology in existing networks and improve overall spectral efficiency in future wireless communication systems.

Referring to FIG. 6, a time-frequency block structure diagram 600 illustrates a Random Access Channel (RACH) procedure in a wireless communication system. The diagram is organized along two axes: frequency on the vertical axis and time on the horizontal axis. The process begins with an RO group 616, which consists of two Random Occasions (ROs). The first RO, designated as RO 1 610, is an SBFD RO associated with Synchronization Signal Block 1 (SSB 1). Immediately following RO 1 is RO 2 612, which is a non-SBFD RO also associated with SSB 1. These two ROs form a contiguous block in the time-frequency domain.

In diagram 600, the UE may detect one or more synchronization signal blocks (SSBs). The configuration information provided to the UE may include a set of available SSB indices. Determining the set of available PRACH resources may comprise mapping the identified time-frequency resources to corresponding SSB indices. This mapping allows the UE to associate specific ROs with particular SSBs, enabling efficient resource allocation and utilization during the random access procedure.

The process of detecting the one or more SSBs may comprise performing a cell search procedure to identify candidate SSBs. This cell search procedure allows the UE to discover and synchronize with nearby cells. Additionally, detecting the SSBs may involve measuring signal quality for each of the identified candidate SSBs. These measurements may help the UE select the most suitable SSB for initiating the random access procedure.

RO 2 is indicated as the “last valid RO” 412 in the RO group. This designation may determine the timing for the UE's PRACH transmission and the network's response.

Following the RO group 616, there is a time slot allocated for the Random Access Response (RAR) corresponding to SSB 1, labeled 414. This RAR period is significantly longer in duration compared to the individual ROs, allowing for the network to process the random access requests and formulate appropriate responses. The extended duration of the RAR period may accommodate multiple UEs attempting random access simultaneously, enhancing the system's ability to handle high-load scenarios.

Diagram 600 represents a cycle of a random access attempt, from the initial RO group to the corresponding RAR period. This structure allows for efficient coordination between UEs and the network during the random access procedure, potentially reducing collisions and improving overall system performance.

The relationship between ROs, SSBs, and the RAR period illustrated in this figure may provide a framework for implementing advanced random access techniques, such as those required for SBFD-aware UEs or other emerging technologies in 5G and beyond networks.

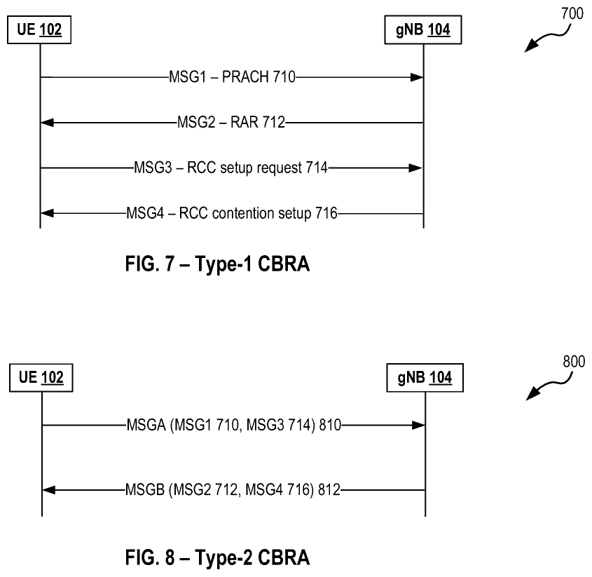

Referring to FIG. 7, a modified Type-1 Contention-Based Random Access (CBRA) communication process 700 is illustrated. The sequence diagram depicts a four-step message exchange between a User Equipment (UE) 102 and a gNodeB (gNB) 104 in a cellular network. The process begins with the UE 102 initiating the random access procedure by sending MSG1 710 message, which contains the Physical Random Access Channel (PRACH) preamble, to the gNB 104.

In some cases, the UE 102 may receive configuration information for a PRACH procedure from the gNB 104. This configuration information may include a PRACH configuration index, a PRACH format, a PRACH time-frequency resource allocation, and a set of available Synchronization Signal Block (SSB) indices. Based on this configuration information, the UE 102 may determine a set of available PRACH resources.

The UE 102 may then detect one or more SSBs. This detection process may involve performing a cell search procedure to identify candidate SSBs and measuring signal quality for each of the identified candidate SSBs. Based on the detected SSBs and the UE's SBFD awareness, the UE 102 may select a PRACH resource from the set of available PRACH resources.

Once the PRACH resource is selected, the UE 102 may calculate a random access radio network temporary identifier (RA-RNTI) using a new formula that includes an SBFD identifier (SBFD_id). The SBFD_id distinguishes between SBFD-aware UEs and non-SBFD UEs when they share a same Random Access Channel (RACH) occasion (RO).

After calculating the RA-RNTI, the UE 102 may transmit MSG1 710 message with a PRACH CBRA-preamble using the selected PRACH resource. The transmission power for the PRACH preamble may be determined based on path loss measurements of the detected SSBs. PRACH transmission occurs if the UE 102 detects an SSB/PBCH signal successfully. Upon detection of the signal, UE 102 knows which RACH occasion (RO) should be used for PRACH transmission.

Upon receiving the PRACH preamble, the gNB 104 responds with MSG2 712 message, which is the Random Access Response (RAR). The RAR typically includes timing advance information, uplink grant, and a temporary identifier for the UE.

Following the receipt of MSG2 712 message, the UE 102 proceeds to transmit as MSG3 714 message, which includes an RRC (Radio Resource Control) setup request. This message is transmitted on the Physical Uplink Shared Channel (PUSCH) and typically includes the UE 102's identity and the reason for establishing the connection.

The final step in this sequence is MSG4 716 message, where the gNB 104 sends MSG4 716 message to the UE 102. MSG4 716 message is the RRC contention resolution message, which confirms the successful completion of the random access procedure and establishes the RRC connection.

The modified Type-1 CBRA communication process 700, as depicted in FIG. 7, provides a framework for reducing PRACH collision in SBFD-aware UEs. By incorporating an SBFD_id into the RA-RNTI calculation, the process can differentiate between SBFD-aware and non-SBFD UEs during the random access procedure, potentially reducing collisions and improving overall system performance.

Continuing with the modified Type-1 Contention-Based Random Access (CBRA) communication process 700, the UE 102 may perform the PRACH procedure as part of various network operations. For instance, the PRACH procedure may be performed as part of an initial access process. In this scenario, the UE 102 may be attempting to establish a connection with the network for the first time or after a period of inactivity. The UE 102 may select a PRACH resource, calculate the RA-RNTI using the modified method for collision avoidance, and transmit the PRACH preamble as previously described. The gNB 104 may then respond with the RAR, and the UE 102 may proceed with the RRC setup request and contention resolution steps to complete the initial access process.

In some cases, the PRACH procedure may be performed as part of a handover process. During a handover, the UE 102 may be transitioning from one cell or sector to another, for example, due to mobility or changing network conditions. The UE 102 may perform the PRACH procedure to establish a connection with the target cell or sector, following the same steps as in the initial access scenario. The modified RA-RNTI calculation method may help reduce PRACH collisions during the handover process, particularly in scenarios involving simultaneous handovers of multiple SBFD-aware and non-SBFD UEs.

In other cases, the PRACH procedure may be performed as part of a beam failure recovery process. Beam failure may occur due to various reasons, such as blockage, fading, or changes in the propagation environment. Upon detecting a beam failure, the UE 102 may initiate the PRACH procedure to re-establish the connection with the network. The use of the modified RA-RNTI calculation method may facilitate efficient resource allocation and reduce PRACH collisions during the beam failure recovery process.

In addition to these scenarios, the UE 102 may adjust a contention window size based on the success or failure of the PRACH procedure. The contention window size determines the number of available slots for retransmission attempts in case of a failed PRACH attempt. By dynamically adjusting the contention window size, the UE 102 may optimize its random access performance, balancing between collision probability and access delay. This feature may be particularly beneficial in high-load scenarios or dense deployments, where the risk of PRACH collisions is high.

In summary, the modified Type-1 CBRA communication process 700, as depicted in FIG. 7, provides a flexible and efficient framework for reducing PRACH collision in SBFD-aware UEs. By incorporating an SBFD_id into the RA-RNTI calculation and adapting the PRACH procedure to various network operations, the process can effectively manage the random access resources and improve the overall performance of the wireless communication system.

Referring to FIG. 8, a collision avoidance Type-2 Contention-Based Random Access (CBRA) communication process 800 is illustrated. The sequence diagram depicts a two-step message exchange between a User Equipment (UE) 102 and a gNodeB (gNB) 104 in a cellular network. The process begins with the UE 102 initiating the random access procedure by sending an MSGA 810 message, which combines the MSG1 710 (Random Access Preamble) and MSG3 714 (RRC Connection Request) into a single transmission. This consolidation of messages aims to reduce the overall random access time compared to the four-step Type-1 CBRA procedure.

Upon receiving MSGA 810 message, the gNB 104 responds with MSGB 812 message. MSGB 812 message combines the MSG2 712 (Random Access Response) message and MSG4 716 (Contention Resolution) message into a single message. This further streamlines the process by allowing the gNB 104 to provide all necessary information for connection establishment in one transmission.

In the modified Type-2 CBRA communication process 800, the UE 102 calculates the Random Access Radio Network Temporary Identifier (RA-RNTI) using the collision avoidance formula that includes an SBFD identifier (SBFD_id). The SBFD_id distinguishes between SBFD-aware UEs and non-SBFD aware UEs. The collision avoidance RA-RNTI calculation method for Type-2 CBRA is as described above with SBFD_id set to 0 for non-SBFD Random Occasions (ROs) and 1 for SBFD ROs. This collision avoidance method allows the network to differentiate between SBFD-aware and non-SBFD UEs during the random access procedure, potentially reducing collisions and improving overall system performance.

In some cases, the UE 102 may receive configuration information for a PRACH procedure from the gNB 104. This configuration information may include a PRACH configuration index, a PRACH format, a PRACH time-frequency resource allocation, and a set of available Synchronization Signal Block (SSB) indices. Based on this configuration information, the UE 102 may determine a set of available PRACH resources.

The UE 102 may then detect one or more SSBs. This detection process may involve performing a cell search procedure to identify candidate SSBs and measuring signal quality for each of the identified candidate SSBs. Based on the detected SSBs and the UE's SBFD awareness, the UE 102 may select a PRACH resource from the set of available PRACH resources.

Once the PRACH resource is selected, the UE 102 may transmit a PRACH CBRA-preamble using the selected PRACH resource. The transmission power for the PRACH preamble may be determined based on path loss measurements of the detected SSBs. PRACH transmission occurs if the UE 102 detects an SSB/PBCH signal successfully. Upon detection of the signal, UE 102 knows which RACH occasion (RO) should be used for PRACH transmission.

The collision avoidance Type-2 CBRA communication process 800, as depicted in FIG. 8, provides a framework for reducing PRACH collision in SBFD-aware UEs. By incorporating an SBFD_id into the RA-RNTI calculation and adapting the PRACH procedure to various network operations, the process can effectively manage the random access resources and improve the overall performance of the wireless communication system.

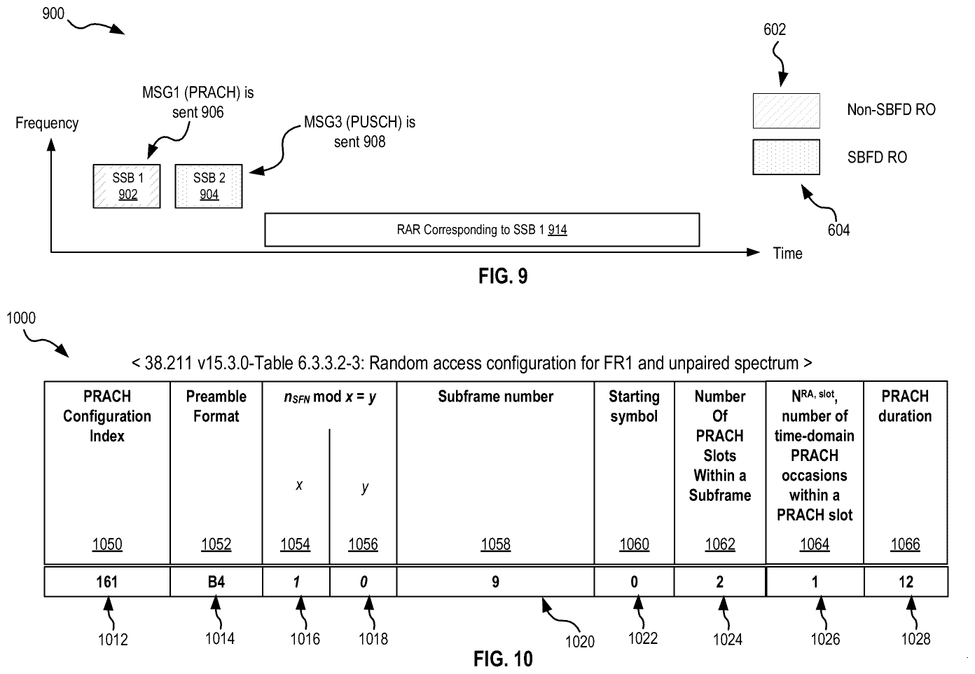

Referring to FIG. 9, a collision avoidance Type-2 Contention-Based Random Access (CBRA) communication 900 for SBFD-aware User Equipment (UE) is illustrated. The sequence diagram depicts a two-step message exchange between a User Equipment (UE) 102 and a gNodeB (gNB) 104 in a cellular network.

The process begins with UE 102 initiating the random access procedure by sending MSGA message as a combined message of MSG1 906 (Random Access Preamble) in RO1 902 and MSG3 908 (RRC Connection Request) in PO1 904. This consolidation of messages aims to reduce the overall random access time compared to the four-step Type-1 CBRA procedure.

In this process, UE 102 may transmit MSG1 in non-SBFD Random Occasion 1 (RO1) 902 and MSG3 in an SBFD PUSCH Occasion 1 (PO1) 904. This structure allows the UE 102 to take advantage of SBFD capabilities during the random access procedure, potentially improving spectral efficiency and reducing latency.

Upon receiving MSGA, the gNB 104 responds with MSGB. MSGB combines the MSG2 (Random Access Response) and MSG4 (Contention Resolution) into a single message. This further streamlines the process by allowing the gNB 104 to provide all necessary information for connection establishment in one transmission.

In the collision avoidance Type-2 CBRA communication process 900, the UE 102 calculates the Random Access Radio Network Temporary Identifier (RA-RNTI) using a collision avoidance formula that includes an SBFD identifier (SBFD_id). The SBFD_id distinguishes between SBFD-aware UEs and non-SBFD UEs when they share a same last Random Access Channel (RACH) occasion (RO). The collision avoidance RA-RNTI calculation method for Type-2 CBRA is as described above with SBFD_id is set to 0 for non-SBFD Random Occasions (ROs) and 1 for SBFD ROs. This new calculation method allows the network to differentiate between SBFD-aware and non-SBFD UEs during the random access procedure, potentially reducing collisions and improving overall system performance.

In some cases, the UE 102 may receive configuration information for a PRACH procedure from the gNB 104. This configuration information may include a PRACH configuration index, a PRACH format, a PRACH time-frequency resource allocation, and a set of available Synchronization Signal Block (SSB) indices. Based on this configuration information, the UE 102 may determine a set of available PRACH resources.

The UE 102 may then detect one or more SSBs. This detection process may involve performing a cell search procedure to identify candidate SSBs and measuring signal quality for each of the identified candidate SSBs. Based on the detected SSBs and the UE's SBFD awareness, the UE 102 may select a PRACH resource from the set of available PRACH resources.

Once the PRACH resource is selected, the UE 102 may transmit a PRACH CBRA-preamble using the selected PRACH resource. The transmission power for the PRACH preamble may be determined based on path loss measurements of the detected SSBs. PRACH transmission occurs if the UE detects an SSB/PBCH signal successfully. Upon detection of the signal, UE knows which RACH occasion (RO) should be used for PRACH transmission.

Upon receiving the PRACH preamble, the gNB 104 responds with a Random Access Response (RAR) 914. This message is transmitted on both the Physical Downlink Control Channel (PDCCH) and the Physical Downlink Shared Channel (PDSCH). The RAR 914 typically includes timing advance information, uplink grant, and a temporary identifier for the UE.

The modified Type-2 CBRA communication process 900, as depicted in FIG. 9, provides a framework for reducing PRACH collision in SBFD-aware UEs. By incorporating an SBFD_id into the RA-RNTI calculation and adapting the PRACH procedure to various network operations, the process can effectively manage the random access resources and improve the overall performance of the wireless communication system.

Referring to FIG. 10, a system diagram 1000 illustrates the random access configurations for Frequency Range 1 (FR1) and unpaired spectrum in a wireless communication system. The diagram presents Configuration Index 161 of Table 1, (above) with multiple columns, each representing different parameters for Physical Random Access Channel (PRACH) configuration.

The PRACH Configuration Index column 1050 displays the PRACH Configuration Index, which is a unique identifier for each PRACH configuration. In this example, the PRACH Configuration Index is 161, as indicated by the element label 1012.

The Preamble Format column 1052 shows the Preamble format used for the PRACH. In this case, the Preamble format is B4, as indicated by the element label 1014. The Preamble format may determine the structure and properties of the PRACH preamble, which is a predefined sequence of symbols used for initial access or uplink synchronization.

The x column 1054 and y column 1056 correspond to the equation “n_{SFN} mod x=y”, where n_{SFN} is the system frame number, x is the periodicity of the PRACH opportunity, and y is the offset within the period. In this example, x (1016) is 1 and y (1018) is 0. This equation may determine the timing of the PRACH opportunity within the system frame.

The Subframe Number column 1058 indicates the Subframe number within the system frame where the PRACH opportunity occurs. In this case, the Subframe number is 9, as indicated by the element label 1020.

The Starting Symbol column 1060 shows the index of the first Orthogonal Frequency Division Multiplexing (OFDM) symbol of the specified RACH occasion. In this example, the Starting symbol is 0, as indicated by the element label 1022.

The Number of PRACH Slots within a Subframe column 1062 represents the number of slots allocated for PRACH transmission within a subframe. In this case, there are 2 PRACH slots within a subframe, as indicated by the element label 1024.

The Number of Time-Domain PRACH Occasions within a PRACH Slot column 1064 displays the number of time-domain PRACH occasions within a PRACH slot. In this example, there is 1 time-domain PRACH occasion within a PRACH slot, as indicated by the element label 1026.

The PRACH Duration column 1066 indicates the duration of the PRACH in terms of the number of OFDM symbols. In this case, the PRACH duration is 12, as indicated by the element label 1028.

The system diagram 1000 provides a comprehensive set of parameters that define how the PRACH is configured and utilized within the wireless communication system for FR1 and unpaired spectrum scenarios. This configuration information, including the PRACH configuration index, PRACH format, and PRACH time-frequency resource allocation, may be provided to the UE as part of the system information broadcast by the base station. Based on this configuration information, the UE may determine a set of available PRACH resources for initiating the random access procedure.

A number of implementations have been described. Nevertheless, it will be understood that various modifications may be made without departing from the spirit and scope of the disclosure. Accordingly, other implementations are within the scope of the following claims.

What is claimed is:

1. A method for reducing Physical Random Access Channel (PRACH) collision between in sub-band full duplex (SBFD)-aware User Equipment (UE) and non-SBFD UEs during a contention-based random access (CBRA) procedure, the method comprising:
receiving, by a UE, configuration information for a CBRA procedure;
determining, by the UE, a set of available PRACH resources based on the received configuration information;
detecting, by the UE, one or more synchronization signal blocks (SSBs);
selecting, by the UE, a PRACH resource from the set of available PRACH resources based on the detected SSBs and SBFD awareness;
calculating, by the UE, a random access radio network temporary identifier (RA-RNTI) using a formula that includes an SBFD identifier (SBFD_id), wherein the SBFD_id distinguishes between SBFD-aware UEs and non-SBFD UEs when they share a same last Random Access Channel (RACH) occasion (RO);
transmitting, by the UE, a PRACH CBRA-preamble using the selected PRACH resource; and
receiving, by the UE, a random access response from a base station based on the calculated RA-RNTI.

2. The method of claim 1, wherein the configuration information includes at least one of:
a PRACH configuration index;
a PRACH format;
a PRACH time-frequency resource allocation; and
a set of available SSB indices.

3. The method of claim 1, wherein determining the set of available PRACH resources comprises:
identifying time-frequency resources allocated for PRACH transmission; and
mapping the identified time-frequency resources to corresponding SSB indices.

4. The method of claim 1, wherein detecting the one or more SSBs comprises:
performing a cell search procedure to identify candidate SSBs; and
measuring signal quality for each of the identified candidate SSBs.

5. The method of claim 1, wherein selecting the PRACH resource based on the detected SSBs and SBFD awareness comprises:
identifying a subset of SSBs with signal quality above a predetermined threshold;
determining an SSB-to-RACH occasion mapping based on the SBFD awareness; and
selecting the PRACH resource associated with a highest quality SSB from the subset of SSBs.

6. The method of claim 1, further comprising determining a transmission power for the PRACH CBRA-preamble based on path loss measurements of the detected SSBs.

7. The method of claim 1, wherein the SBFD awareness comprises knowledge of frequency locations of SSBs within a carrier bandwidth.

8. The method of claim 1, wherein:
the configuration information comprises SSB/PBCH information, the SSB/PBCH information comprising at least one of: (i) SIB-1 in 5G, or (ii) SIB-2 in LTE; and
the set of available PRACH resources comprises at least one system frame number and at least one sub-frame number.

9. The method of claim 1, wherein the CBRA procedure is performed as part of an initial access, a handover, or a beam failure recovery process.

10. The method of claim 1, further comprising adjusting a contention window size based on the success or failure of the CBRA procedure.

11. A system for reducing Physical Random Access Channel (PRACH) collision in sub-band full duplex (SBFD)-aware operation, the system comprising:
a base station; and
a User Equipment (UE) comprising:
a transceiver;
a memory; and
a processor coupled to the transceiver and the memory, wherein the processor is configured to:
receive configuration information for a CBRA procedure from the base station;
determine a set of available PRACH resources based on the received configuration information;
detect one or more synchronization signal blocks (SSBs);
select a PRACH resource from the set of available PRACH resources based on the detected SSBs and SBFD awareness;
calculate a random access radio network temporary identifier (RA-RNTI) using a formula that includes an SBFD identifier (SBFD_id), wherein the SBFD_id distinguishes between SBFD-aware UEs and non-SBFD UEs when they share a same last Random Access Channel (RACH) occasion (RO);
transmit a PRACH CBRA-preamble using the selected PRACH resource; and
receive a random access response from the base station based on the calculated RA-RNTI.

12. The system of claim 11, wherein the configuration information includes at least one of:
a PRACH configuration index;
a PRACH format;
a PRACH time-frequency resource allocation; and
a set of available SSB indices.

13. The system of claim 11, wherein to determine the set of available PRACH resources, the processor is further configured to:
identify time-frequency resources allocated for PRACH transmission; and
map the identified time-frequency resources to corresponding SSB indices.

14. The system of claim 11, wherein to detect the one or more SSBs, the processor is further configured to:
perform a cell search procedure to identify candidate SSBs; and
measure signal quality for each of the identified candidate SSBs.

15. The system of claim 11, wherein to select the PRACH resource based on the detected SSBs and SBFD awareness, the processor is further configured to:
identify a subset of SSBs with signal quality above a predetermined threshold;
determine an SSB-to-RACH occasion mapping based on the SBFD awareness; and
select the PRACH resource associated with a highest quality SSB from the subset of SSBs.

16. The system of claim 11, wherein the processor is further configured to determine a transmission power for the PRACH CBRA-preamble based on path loss measurements of the detected SSBs.

17. The system of claim 11, wherein the SBFD awareness comprises knowledge of frequency locations of SSBs within a carrier bandwidth.

18. The system of claim 11, wherein:
the configuration information comprises SSB/PBCH information, the SSB/PBCH information comprising at least one of: (i) SIB-1 in 5G, or (ii) SIB-2 in LTE; and
the set of available PRACH resources comprises at least one system frame number and at least one sub-frame number.

19. The system of claim 11, wherein the CBRA procedure is performed as part of an initial access, a handover, or a beam failure recovery process.

20. The system of claim 11, wherein the processor is further configured to adjust a contention window size based on the success or failure of the CBRA procedure.

21. A method for reducing Physical Random Access Channel (PRACH) collision in sub-band full duplex (SBFD)-aware UEs aware User Equipment (UE), the method comprising:
receiving, by a UE, configuration information for a PRACH procedure;
determining, by the UE, a set of available PRACH resources based on the received configuration information;
detecting, by the UE, one or more synchronization signal blocks (SSBs);
selecting, by the UE, a PRACH resource from the set of available PRACH resources based on the detected SSBs and SBFD awareness;
transmitting, by the UE, a PRACH CBRA-preamble using the selected PRACH resource; and
receiving, by the UE, a random access response from a base station.

22. The method of claim 21, wherein the configuration information includes at least one of:
a PRACH configuration index;
a PRACH format;
a PRACH time-frequency resource allocation; and
a set of available SSB indices.

23. The method of claim 21, wherein determining the set of available PRACH resources comprises:
identifying time-frequency resources allocated for PRACH transmission; and
mapping the identified time-frequency resources to corresponding SSB indices.

24. The method of claim 21, wherein detecting the one or more SSBs comprises:
performing a cell search procedure to identify candidate SSBs; and
measuring signal quality for each of the identified candidate SSBs.

25. The method of claim 21, wherein selecting the PRACH resource based on the detected SSBs and SBFD awareness comprises:
identifying a subset of SSBs with signal quality above a predetermined threshold;
determining an SSB-to-RACH occasion mapping based on the SBFD awareness; and
selecting the PRACH resource associated with a highest quality SSB from the subset of SSBs.

26. The method of claim 21, further comprising:
determining a transmission power for the PRACH CBRA-preamble based on path loss measurements of the detected SSBs.

27. The method of claim 21, wherein the SBFD awareness comprises knowledge of frequency locations of SSBs within a carrier bandwidth.

28. The method of claim 21, wherein:
the configuration information comprises SSB/PBCH information, the SSB/PBCH information comprising at least one of: (i) SIB-1 in 5G, or (ii) SIB-2 in LTE; and
the set of available PRACH resources comprises at least one system frame number and at least one sub-frame number.

29. The method of claim 21, wherein the PRACH procedure is performed as part of an initial access, a handover, or a beam failure recovery process.

30. The method of claim 21, further comprising:
adjusting a contention window size based on the success or failure of the PRACH procedure.

31. A system for reducing Physical Random Access Channel (PRACH) collision in sub-band full duplex (SBFD)-aware operation, the system comprising:
a base station; and
a User Equipment (UE) comprising:
a transceiver;
a memory; and
a processor coupled to the transceiver and the memory, wherein the processor is configured to:
receive configuration information for a PRACH procedure from the base station;
determine a set of available PRACH resources based on the received configuration information;
detect one or more synchronization signal blocks (SSBs);
select a PRACH resource from the set of available PRACH resources based on the detected SSBs and SBFD awareness;
transmit a PRACH preamble using the selected PRACH resource; and
receive a random access response from the base station.

32. The system of claim 31, wherein the configuration information includes at least one of:
a PRACH configuration index;
a PRACH format;
a PRACH time-frequency resource allocation; and
a set of available SSB indices.

33. The system of claim 31, wherein to determine the set of available PRACH resources, the processor is further configured to:
identify time-frequency resources allocated for PRACH transmission; and
map the identified time-frequency resources to corresponding SSB indices.

34. The system of claim 31, wherein to detect the one or more SSBs, the processor is further configured to:
perform a cell search procedure to identify candidate SSBs; and
measure signal quality for each of the identified candidate SSBs.

35. The system of claim 31, wherein to select the PRACH resource based on the detected SSBs and SBFD awareness, the processor is further configured to:
identify a subset of SSBs with signal quality above a predetermined threshold;
determine an SSB-to-RACH occasion mapping based on the SBFD awareness; and
select the PRACH resource associated with a highest quality SSB from the subset of SSBs.

36. The system of claim 31, wherein the processor is further configured to:
determine a transmission power for the PRACH preamble based on path loss measurements of the detected SSBs.

37. The system of claim 31, wherein the SBFD awareness comprises knowledge of frequency locations of SSBs within a carrier bandwidth.

38. The system of claim 31, wherein:
the configuration information comprises SSB/PBCH information, the SSB/PBCH information comprising at least one of: (i) SIB-1 in 5G, or (ii) SIB-2 in LTE; and
the set of available PRACH resources comprises at least one system frame number and at least one sub-frame number.

39. The system of claim 31, wherein the PRACH procedure is performed as part of an initial access, a handover, or a beam failure recovery process.

40. The system of claim 31, wherein the processor is further configured to:
adjust a contention window size based on the success or failure of the PRACH procedure.
